(19) United States
(12) Patent Application Publication
(10) Pub. No.: US 2025/0342761 A1
(43) Pub. Date: Nov. 6, 2025

(54) TOILET SENSOR

(71) Applicant: TIDI PRODUCTS, LLC, Neenah, WI (US)

(72) Inventor: Andrew VanDeWeghe, Grayslake, IL (US)

(21) Appl. No.: 18/865,043

(22) PCT Filed: May 15, 2023
(86) PCT No.: PCT/US2023/022233

§ 371 Date: Nov. 12, 2024

Related U.S. Application Data
(60) Provisional application No. 63/343,293, filed on May 18, 2022.

(51) Int. Cl. G08B 21/04; A47K 13/24

(52) U.S. Cl. CPC G08B 21/0461; A47K 13/24

(57) ABSTRACT

A sensor may be used in combination with a monitoring system. The sensor may include a housing, with the housing including an upper portion, an outer sidewall extending downwardly from the upper portion, an inner sidewall extending downwardly from the upper portion, and a lower portion joined with the upper portion. The upper and lower portions may be convex. A first film layer having a first conductive area may be disposed adjacent to the upper portion of the housing such that the first conductive area faces opposite the upper portion of the housing, while a second film layer having a second conductive area, may be disposed adjacent to but separated from the first film layer such that the second conductive area faces the first conductive area. The sensor may further include a processing circuitry contained within the housing.

### PRIORITY CLAIM

This application claims priority to U.S. Provisional Application No. 63/343,293, filed May 18, 2022, the contents of which are herein incorporated by reference.

### BACKGROUND OF THE INVENTION

Patient monitoring systems are often used in healthcare and care facilities to provide an early warning as to when a patient who is as at risk of falling is attempting to get up without assistance. While patient monitoring systems, on their own, do not prevent falls, they may provide advance notification to others, such as nurses or healthcare aides, that a patient is or may be moving from the sensor so that assistance can be rendered.

### BRIEF DESCRIPTION OF THE DRAWINGS

FIG. 1 is an exploded perspective top front view of an example toilet sensor consistent with the present disclosure;

FIG. 2 is an exploded perspective bottom back view of the example toilet sensor of FIG. 1;

FIG. 3 is a cross-section view of an upper portion of a housing for a toilet sensor consistent with the present disclosure;

FIG. 4 is top front perspective view of an assembled together example of of the example toilet sensor of FIG. 1;

FIG. 5 is an exploded perspective top front view of an example of a sensor system including a toilet sensor consistent with the present disclosure;

FIG. 6A is a front view of a conventional toilet with toilet seat attached thereto and in a lowered sitting position without any sensor between the toilet seat and the toilet bowl;

FIG. 6B is a front view of that seen in FIG. 6A but now with the toilet sensor of FIG. 4 installed consistent with the present disclosure between the toilet seat and the toilet bowl and the sensor not significantly disrupting the usual positioning of the toilet seat relative to the toilet bowl in the absence of the sensor therebetween;

FIG. 7A is a side view of that seen in FIG. 6A;

FIG. 7B is a side view of that seen in FIG. 6B;

FIG. 8 is a cross-section view of an assembled toilet sensor taken along line 8-8 in FIG. 4;

FIG. 9 is a back view of an assembled toilet sensor of the example toilet sensor of FIG. 1;

FIG. 10 is an exploded schematic view of components of an assembled toilet sensor consistent with the present disclosure and looking into either leg of the sensor similar to the legs seen in FIG. 9;

FIG. 11 is a back view of a housing for a toilet sensor consistent with the present disclosure;

FIG. 12 is a bottom view of the housing for that seen in FIG. 11; and

FIG. 13 is a perspective bottom view of the housing for that seen in FIG. 11.

### DETAILED DESCRIPTION

Patient monitoring systems often form an integral part of safety systems within healthcare and care facility settings. Often, these patient monitoring systems are used to alert nurses, caregivers, or others to movement of a patient, and particularly patients who may be at risk of falling. While patient monitoring systems themselves do not prevent falls, they may serve to alert and notify others that the patient is moving or is about to move from the sensor unassisted, allowing a nurse or caregiver to go render aid proactively.

In general, patient monitoring systems include a device connected to a pressure sensitive sensor or mat. The device may be placed in a variety of locations, including, but not limited to, a bed, a chair, or a toilet. When a patient rests on the sensor, the device may be triggered to begin monitoring. Then, when the patient moves from the sensor, unless monitoring is suspended or powered down, the device can initiate an alarm or an alert. The alarm could be, for example, an indicator light, an audible tone, a playback of a recorded statement to return to the sensor, or a message played at a nurse call station.

One particular area of importance for monitoring is the toilet. Patients understandably desire privacy when using the toilet; however, patients may still require assistance standing up from the toilet when they are finished. Accordingly, it is desirable to install a patient monitoring system within or as part of a toilet.

One such type of monitoring system is a corded, or wired, system. In a wired system, a sensor is placed within the toileting area, often under a portion of the toilet seat. The sensor has a wire extending therefrom, which may be connected to a monitor or other alarming device. This monitor may be located either within the bathroom or externally to the bathroom. Due to the wired connection between the sensor and the monitor, the sensor may transmit an electrical signal, via the wire, to the monitor when the sensor detects movement.

However, wired systems come with several drawbacks. The first is that wired systems inherently include additional components, such as the cord, that present additional cleaning and sanitation concerns, particularly in an environment such as a bathroom. Additionally, inclusion of a cord may present an additional tripping hazard for both a caregiver and a patient.

A solution to the problems presented by a wired system is making the system wireless. In a wireless system, a sensor, or several sensors, are placed within the toilet system, again, often under a portion of the toilet seat. These wireless sensors may include a pair of conductive layers separated by some type of non-conductive material, such as foam. The non-conductive material may have openings disposed therein, such that when a patient is seated on the toilet, and thus on the sensor, the two conductive layers are able to make contact, thus completing an electrical circuit. A wireless transmitter may be located within the sensor such that, when the conductive layers are in contact, the wireless transmitter transmits wireless signals to a remote receiver. When a patient moves off the sensor, the wireless transmitter may transmit a signal to the receiver to alert a nurse or caregiver. An example of this sensor system is discussed in WO 2022/241020 to TIDI Products, LLC, the contents of which are herein incorporated by reference.

Although a wireless system may eliminate the specific concerns present with a wired system, existing systems for a toilet sensor, whether wired or wireless, still leave room for improvement. First, installation of the sensors can be difficult. Precise placement is necessary to ensure that a majority of patients will, when seated, trigger at least some portions of the sensor. If a sensor is placed too far back, for example, a patient seated on the toilet may not engage the sensor when they sit down, and thus will not trigger an alarm when they attempt to get up. Similarly, if a sensor is placed too close to the front of the toilet, a patient seated further back may not engage the sensor at all, or enough to make consistent and/or reliable.

In addition, use of a non-conductive separating material, such as foam or other relatively think material, may cause alterations to the profile of the toilet seat. For example, if the conductive layers are separated by an inch of foam material, installation of the sensor will raise the toilet seat by about that amount. Then, once a patient sits on the toilet, the foam will compress, and the toilet seat could move accordingly. For patients who are already at risk for falls, this additional amount of instability may be difficult to handle, particularly with respect to stabilization. Additionally, since the sensor does not encompass the entire toilet seat area, different portions of the toilet seat may be raised with nothing underneath, which may lead to the patient feeling unstable when seated on the toilet.

Finally, such sensors may not always engage or not engage consistently, presenting reliability problems. If a patient is seated oddly on the toilet seat, the sensor is incorrectly placed, or the patient is particularly lightweight and thus does not generate sufficient force to compress the non-conductive material, the sensor may not engage. Without proper engagement of the sensor, an alert will not be triggered when the patient attempts to stand up. As a result, if a sensor is not engaged, a patient is either placed at an increased risk of a fall or will be forced to allow a caregiver to remain with them while they are using the bathroom.

The toilet sensor of the present disclosure, by contrast, preferably uses a low-profile design and preferably with a substantially (i.e., exactly parabolic to essentially parabolic allowing for some variation plus and minus 20% off of exactly parabolic) parabolically shaped housing that is more easily installable on a majority of toilets in hospitals and caregiving settings. The toilet sensor may also by merely curved and not parabolically shaped, in other aspects. In some examples, the toilet sensor may be rounded. The low-profile design, preferably that portion of the housing located between the toilet seat and the toilet bowl, further reduces the extent to which the sensor causes the toilet seat to be raised or angled from its normal position, providing users with a more stable and comfortable experience when using the toilet. In addition, a toilet sensor consistent with the present disclosure may be manufactured using firmer materials, such that a user will not experience a “compression” when sitting down. A toilet sensor consistent with the present disclosure may include a housing having an upper portion and a lower portion. A pair of film layers having conductive areas may be disposed between the upper portion and the lower portion of the housing. The pair of film layers may be separated by non-conductive spacing material. The housing may further include processing circuitry having a connection or, preferably, a wireless transmitter or antenna to transmit signals to an external receiver to alert a caregiver when a patient is attempting to get up from the toilet.

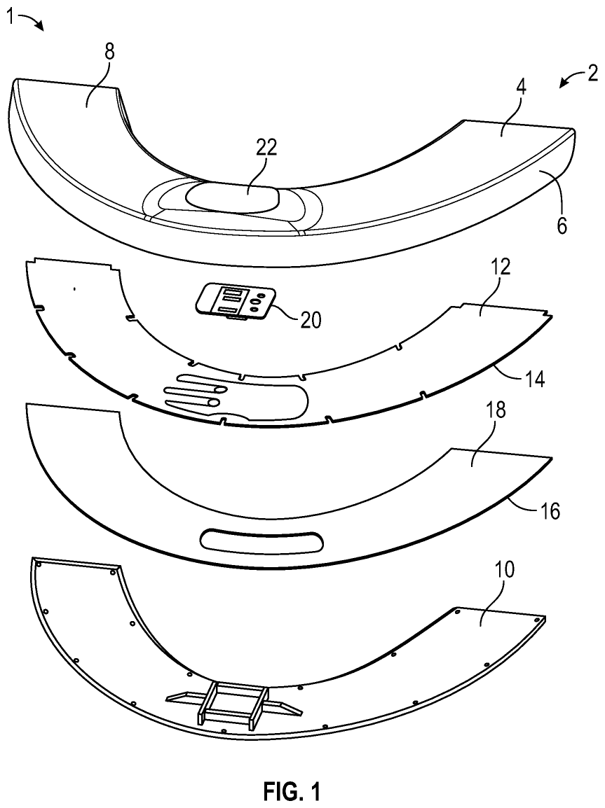

FIG. 1 is an example of a toilet sensor 1 consistent with the present disclosure. Sensor 1 includes a housing 2. Housing 2 may include an upper portion 4. Preferably, portion 4 has a total thickness (e.g., dimensions 5a plus 5b, see FIG. 3) of between about 0.005 inch and 0.3 inch, and more preferably between about 0.05 inch and 0.15 inch. Extending downwardly from the upper portion 4 may be an outer sidewall 6 and an inner sidewall 8. The outer sidewall 6 and the inner sidewall 8 may extend downwardly at an angle; this configuration is discussed further herein with respect to FIG. 3. Also, for example (and not expressly shown in the Figures, but well understood here), sidewalls 6 and 8 can be configured so walls 6 and/or 8 do not extend down along the entire parabolic shape, i.e., there can be notches or even big gaps with really limited portions or “fingers” of sidewall 6, 8 extending down from the upper portion.

Upper portion 4 may be manufactured of polypropylene or another plastic, metal or composite material having a semi-rigid to rigid durometer. More specifically, upper portion 4 may be manufactured of a material having a durometer of between about 20 to 100 on the Shore A Hardness scale (and even as much as about 80 on the Shore D Hardness scale), e.g., when portion 4 is a plastic or elastomeric material, or such material having a comparable rigidity should the material be made out of something not readily measurable on the Shore Hardness scale. More preferably, the upper portion can have a durometer of between about 60 and 100 on the Shore A Hardness scale (and comparably between about 0 and 60 on the Shore D Hardness scale), and even more preferably between about 80 and 100 on the Shore A Hardness scale (and comparably between about 30 and 60 on the Shore D Hardness scale). In some examples, the upper portion 4 of housing 2 may be manufactured using injection molding.

Housing 2 further includes a lower portion 10. Lower portion 10 may be joinable with upper portion 4, and is preferably joined therewith, when housing 2 is completely constructed and sensor 1 is ready for use by the intended user. Preferably, when sensor 1 is completely constructed and ready for use, it has a low-profile. Such a low-profile means that the total thickness of the housing is less than about 0.4 inches, and in increasing order of more preference, less than about: 0.35 inches, 0.3 inches, 0.25 inches, 0.2 inches or 0.15 inches. Accordingly, and in combination with the thickness for the upper portion disclosed previously, the lower portion preferably has a total thickness of between about 0.005 inch and 0.3 inch, and more preferably between about 0.08 inch and 0.18 inch. Lower portion 10 may be manufactured of rubber, thermoplastic elastomer material, or any other suitable medium soft to semi-rigid durometer material. More particularly, lower portion 10 may be manufactured of a material having a durometer no more than about 80 on the Shore A Hardness scale. Importantly, the material of lower portion 10 may be less hard than the material of upper portion 4, allowing lower portion 10 to “grip” the toilet bowl 40 when installed, especially as compared to the rigidity/hardness and function of the upper portion. For example, more preferably the lower portion 10 can have a durometer of between about 20 and 70 on the Shore A Hardness scale (and only partially comparable on the Shore D Hardness scale), and even more preferably between about 40 and 70 on the Shore A Hardness scale. In some examples, the lower portion 10 of housing 2 may be manufactured using injection molding.

In related aspects of the housing, in addition to the durometer characteristic or as an alternative, it can be an elastomeric characteristic or its absence, that is employed. For example, it can be preferred to provide different elastomeric qualities for the upper portion and the lower portion. That is, the upper portion can be non-elastomeric and the lower portion elastomeric, or the upper portion can be elastomeric as long as it is less elastic than the lower portion. In another aspect, the upper and/or lower portion could be a combination material that is non-elastomeric and elastomeric, for example, preferably non-elastomeric for the part (or whole) of the upper portion facing the toilet seat and elastomeric for the part (or whole) of the lower portion that is facing the toilet bowl, and more preferably, elastomeric for the part of the lower portion that is engaging the toilet bowl. Additionally, and for all disclosed characteristics of the housing, including those of the upper and lower portions, such can be made of multi-material construction (e.g., overmolded, co-molded, or sequentially joined together) with areas of different material having different durometers, different coefficients of friction and different elastomeric characteristics, as opposed to be homogeneous throughout or at their surface.

Still in a further related aspect, it can be the coefficient of friction that is a preferred characteristic for the housing, i.e., the friction between the lower portion and the toilet bowl most preferably. Additionally, it is more preferable to have the lower portion with a high coefficient of friction than the upper portion. For example, for each of: the friction. the durometer and the elastomeric characteristics, and in particular when a differential of these characteristics for the upper portion as compared to the lower portion, benefits that may be achieved are (i) being able to better seal out liquids (e.g., by mating firmly where parts meet), and/or (ii) helping more evenly spread the force of the user exerted onto the housing to help squeeze or compress the sensing film layers 12, 16 in selected areas, and thereby more consistently function to be a closed circuit when sufficient pressure is applied to the housing and an open circuit when insufficient pressure is applied to the housing. In this way, it helps the processing circuitry properly communicate the presence and absence of the user on the toilet before, during and after use of the toilet for toileting.

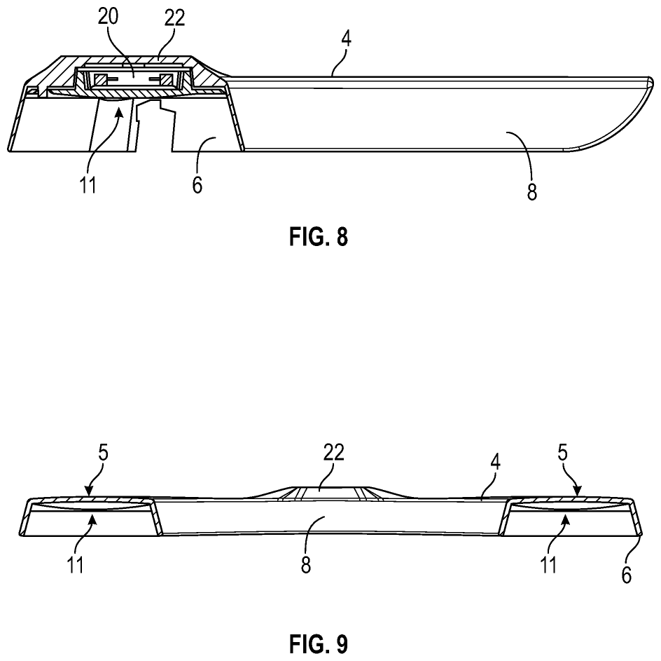

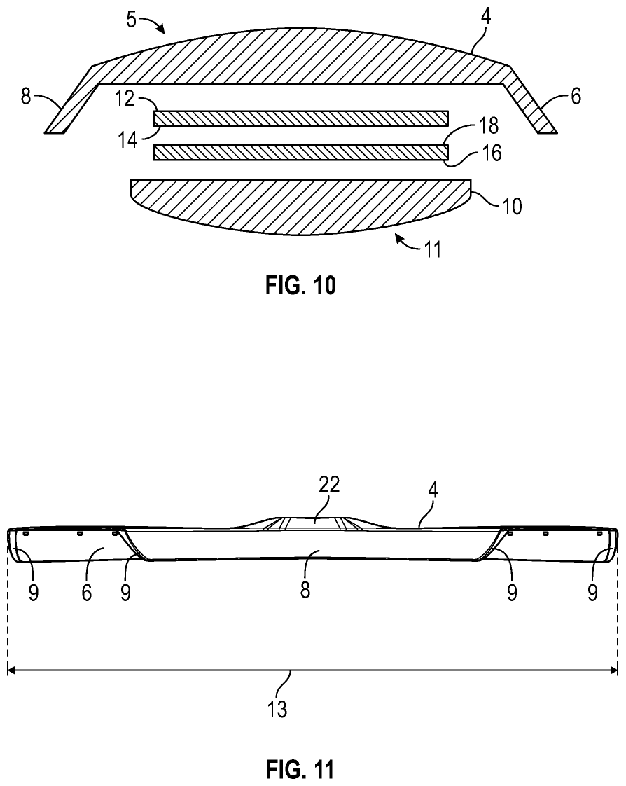

In some examples, upper portion 4 and/or lower portion 10 may be convex. That is, upper portion 4 and/or lower portion 10 may not be entirely horizontal and flat for one or both of their top and bottom surfaces but may have a curvature with respect to a horizontal axis for one or both of their top and bottom surfaces. More preferably, and as seen in FIGS. 3 and 9-10, the convex configuration of upper portion 4 can be top surface 5 convex upwardly and projecting away from lower portion 10. For example, this can be portion 5a-5a being uniform across width 7 and portion 5b-5b being thicker in the middle than at either ends of width 7. Additionally or alternately, and as seen in FIGS. 8-10, more preferably the convex configuration of lower portion 10 can be bottom surface 11 convex downwardly and projecting away from upper portion 4. The way to achieve convex lower portion can be similar to that for upper portion 4, namely, having part (not detailed this way in FIG. 10, but would be understood a such based on description here) like portion 5a-5a (FIG. 3) being uniform across width 7 and part (not detailed this way in FIG. 10, but would be understood a such based on description here) like portion 5b-5b (FIG. 3) being thicker in the middle than at either ends of width 7. Even more preferably, the upper and lower portions each have a convex area, with each area projecting away from the other area (e.g., as most clearly seen in FIGS. 9 and 10, with surfaces 5 and 11), and most preferably, the apex of each dome sitting exactly opposite the apex of the other dome. Without being limited to a theory of understanding, the inventor has discovered that adding the convex configuration to one or both of the portions 4 and 10 can enhance the efficacy and/or compatibility of the sensor 1 with many different toilets having various toilet bowel and toilet seat sizes, shapes and configurations, including various toilet seat bumper types and locations. That is, the convex configuration for one or both of the portions 4, 10 can help to better ensure contact between the conductive areas of film layers 12 and 16, when and as desired for operation of sensor 1, thus enhancing sensor efficacy.

A first film layer 12 may be included within the sensor 1. First film layer 12 may include a first conductive area 14. First film layer 12 may be disposed adjacent to the upper portion 4 of housing 2, such that, when installed, the first conductive area 14 faces opposite the upper portion 4 of housing 2. Said differently, when first film layer 12 is coupled to housing 2 at the upper portion 4 thereof, the conductive area 14 may face away from the upper portion 4.

A second film layer 16 may also be included within the sensor 1. Second film layer 16 may include a second conductive area 18, similar to first conductive area 16. When placed in the sensor 1, second film layer 16 may be disposed adjacent to the first film layer 12, such that the second conductive area 18 faces the first conductive area 16. Importantly, however, the second conductive area 18 is selectively separate from the first conductive area 14. See FIG. 10 for a sectional view of housing 2 showing the first film layer 12 and the second film layer 16.

Both the first film layer 12 and the second film layer 16 may be manufactured of polyethylene terephthalate (PET) or similar material. The thickness of the PET film may be quite small, around 0.005 inches. The two layers can be formed separately and then joined together before being joined into the housing, formed separately and then joined together only when being joined into the housing, or formed together more like a single structure yet having at least electrical separation between the two layers and then that structure joined into the housing. The film layers, when joined together, can be joined in a variety of ways. For example, they can be joined primarily about their perimeter and with the are inside the perimeter the most sensitive area for detecting electrical contact between the two layer when the sensor is subject to sufficient force by the user sitting on the toilet seat with the sensor located between the toilet seat and toilet bowl. The conductive areas 14, 18 may be included within the PET, and may be manufactured using conductive ink (e.g., typically applied on the film by screen printing), vacuum deposition (e.g., typically for aluminum or applying another type of metal), or any other suitable technology to create conductive areas on PET, and preferably selected conductive areas. In some examples, one of the conductive areas 14, 18 may include a plurality of distinct conductive paths between processing circuitry (e.g., a microchip, a microcontroller, and/or printed circuit board (discussed further herein) and a plurality of sensing areas. As such, the conductive material and/or paths may directly or indirectly connect with the processing circuitry, and electrical connection can be made by other parts or materials of the sensor 1 here. For example, a smaller film assembly, with 2 wires connecting the conductive ink to the circuit board, can be used. The conductive areas 14, 18 may include a patterned set of conductive material, such that when the first conductive area 14 contacts the second conductive area 18, the patterned set of conductive material bridges the plurality of conductive paths, thus completing a circuit and transmitting electrical signals. Additionally, processing circuitry may use plain wires or other ways currently available to provide electrical connections between components. One means is “flex circuits” which are similar to a traditional printed circuit board but use thin and flexible polymer film as a substrate instead of traditional fiber reinforced plastic board. An additional example is an integrated component which serves both as the “sensing film” and as a flexible substrate for other electronic components (microcontroller, battery, etc.), with conductive traces for sensing and to connect the downstream components.

Examples are not so limited, however, and other patterns and methods of conductive paths and conductive material may be used. Importantly, the conductive areas 14, 18 preferably cover a substantial portion of the first film layer 12 and the second film layer 16, respectively. That is, the conductive areas 14, 18 of toilet sensor 1 are large enough, and preferably the larger the better within the footprint of sensor 1, helping to ensure that a patient will activate the sensor regardless of where or how they sit on the toilet, and regardless the toilet bowel/seat/seat-bumper size, shape and configuration. Further, if desired, left and right areas of housing 4 on either side of the vertex can be configured as a parallel electrical circuit, so pressing either side provides a conductive pathway. Alternatively, the sides can be configured as a series electrical circuit, meaning both sides need to be pressed to complete the conductive pathway, which would alarm send a signal if the user's weight is sufficiently reduced on just one side.

In addition, the second conductive area 18 may be separated from the first conductive area 14 by a pattern of non-conductive spacing material on the first film layer 12 and/or the second film layer 16, or formed by or deposited on an additional layer that is directly or indirectly joined with the first and/or second layer 12, 16. The non-conductive spacing material may be any type of non-conductive material deposited onto the film and/or joined to or associated with the conductive material and may serve to selectively separate physically and/or electrically the first film layer 12 and the second film layer 16. When the toilet sensor 1 is not in use by a person thereon, the non-conductive spacing material may serve to keep a circuit from being completed by the first conductive area 14 and the second conductive area 18. However, when the toilet sensor 1 is in use by a person thereon, the non-conductive spacing material may be sufficiently overcome mechanically and/or electrically to enable the first conductive area 14 to contact the second conductive area 18, allowing completion of a circuit, as discussed above. For example, the relatively flexible housing materials and/or their desired durometer, help enable this, even if the force happens to be applied at a location where spacing material is present, and thereby in essence “bulging” into the openings. Stated further, it is preferred to have a pattern with enough gaps (size, number, spacing) to be efficacious in use. Additionally, preferably, by selecting appropriate thickness and mechanical properties (especially stiffness) of the film layers and their spacing material, the sensor will make and break contact at clinically acceptable force levels. The force threshold must be high enough (for example at least 5 pounds force, and may be desirable for up to 10 pounds or a little more) so the weight of an unoccupied toilet seat does not inadvertently register as a user sitting thereon. Conversely, the force threshold must be low enough for lighter users to activate the sensor, even after accounting for some of their weight being supported by the rear hinge of the toilet seat and by the floor (if feet and lower legs are resting on floor).

Toilet sensor 1 may further include processing circuitry 20. As used herein, processing circuitry refers to features that provide an electronic means of interfacing between one or more areas of the sensor which are affected by patient weight, and downstream components. Processing circuitry 20 may optionally include a microcontroller. As used herein, a microcontroller refers to an integrated circuit that contains a microprocessor along with memory and associated circuits. The memory, microprocessor, and assorted circuits control some or all of the functions of an electronic device or system. Processing circuitry 20 may include a battery and antenna and may be coupled to the first film layer 12 and/or the second film layer 16. As shown in FIG. 1, processing circuitry 20 may be contained within the housing 2. More particularly, upper portion 4 of housing 2 may include a casing 22 for receiving and holding the processing circuitry 20 within the housing 2. In a preferred embodiment, the antenna is wireless, although examples are not so limited and the printed circuit board, with or without an antenna. may be wire connected to a receiver, e.g., via a wired connection.

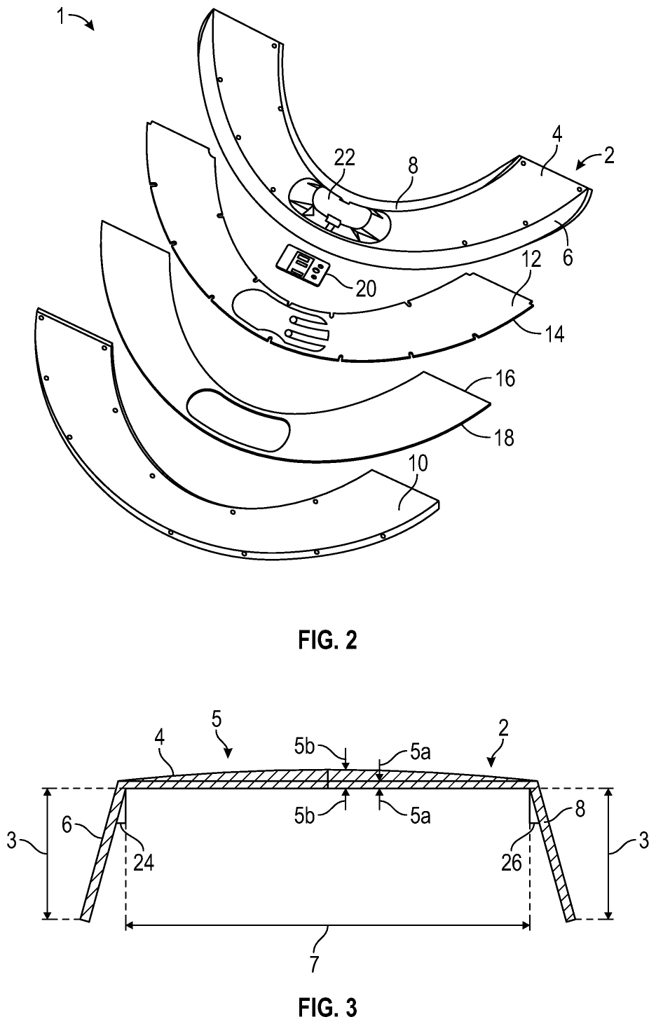

FIG. 2 is another view of the example toilet sensor 1 of FIG. 1. More specifically, FIG. 2 is an upside-down view of toilet sensor 1. As can be seen in FIG. 2, upper portion 4 of housing 2 includes a casing 22 which is able to receive and hold processing circuitry 20. The casing 22 may “grip” the processing circuitry 20 to hold it in place, although examples are not so limited.

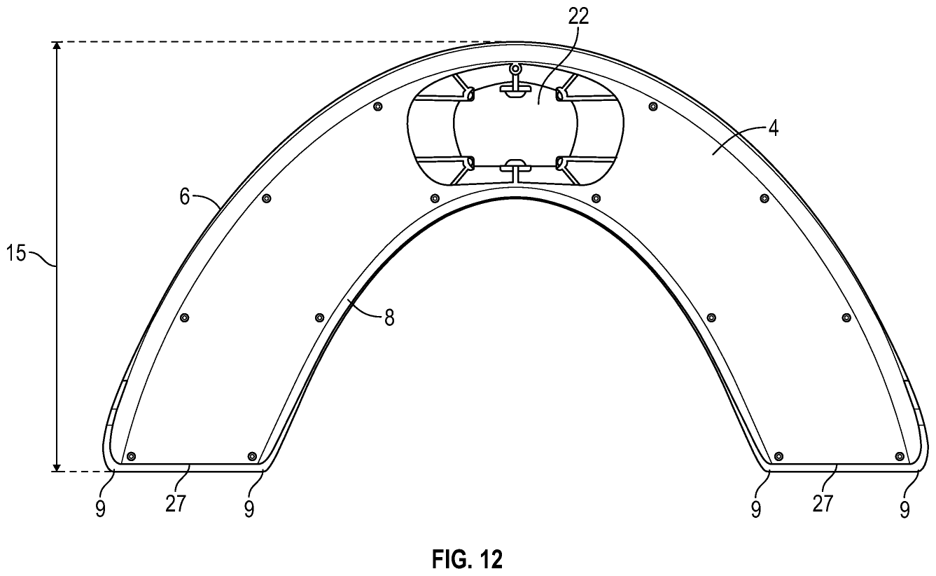

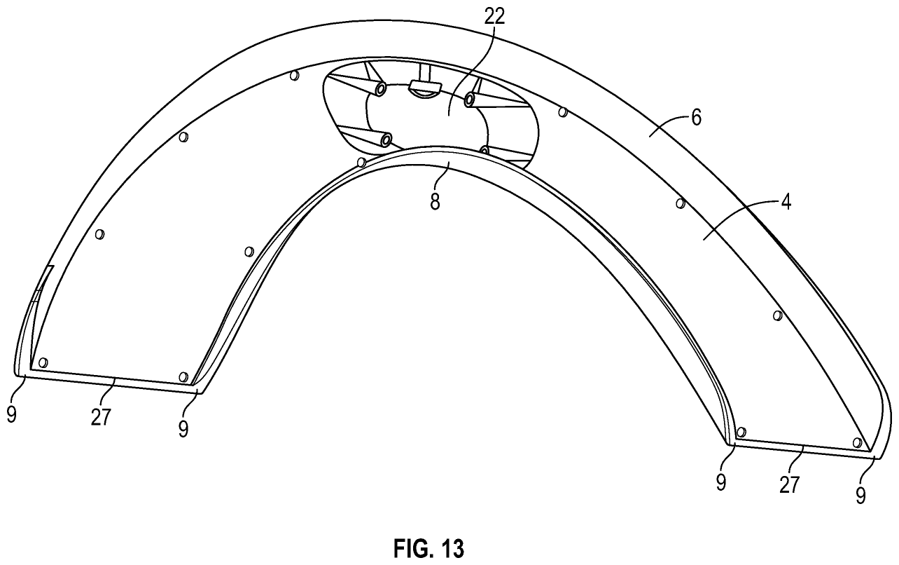

As can be seen in both FIGS. 1 and 2, toilet sensor 1, and many of the components therein, may be substantially parabolic in shape. The parabola may be sized and angled such that the toilet sensor 1 is able to fit onto a majority of existing toilet seats. Toilet sensor 1 may have a maximum outer diameter 13 (FIG. 11) of between about 10 inches to about 15 inches, and more preferably between about 12 inches to 14 inches, as measured from the open ends of housing 2. Toilet sensor 1 may further have a length 15 (FIG. 12) of between about 5 inches to about 9 inches, and more preferably between about 6 inches to 8 inches, as measured from a center of housing 2 to a line drawn between the open ends of housing 2. Further, toilet sensor 1 may have a width 7 (e.g., FIG. 3) of between about 1 inch to 3 inches, more preferably between about 1.5 inches to 2.5 inches, as measured between outer side wall 6 and inner side wall 8. However, examples are not so limited, and other dimensions may be used.

Importantly, the dimensions of toilet sensor 1 may serve to aid in ease of use of toilet sensor 1. As a result of its substantially parabolic shape, toilet sensor 1 may be intuitive to install and have a smaller margin of error when installing. Toilet sensor 1 is, due to its shape, only installable one way: with the front portion of the housing 2 facing the front of the toilet and with the rear leg portions extending backwardly along the toilet bowl. Outer side wall 6 may lie along the outer portion of the toilet bowl, while inner side wall 8 may lie along the inner portion of the toilet bowl. Further in this regard, and as related to other description elsewhere herein too, the housing width 7, and preferably including the sidewalls too, is about as wide as the toilet seat under which sensor 1 sits in use. In this way, preferably, the sensor 1 profile “hides” or sits within the vertical profile of the toilet seat so as to not interfere with, or be readily noticeable to, the user sitting on the toilet seat with sensor thereunder.

FIG. 3 is a view of an upper portion 4 of a housing 2 for a toilet sensor consistent with the present disclosure. As shown in FIG. 3, upper portion 4 of housing 2 includes an outer side wall 6 and an inner side wall 8. The outer side wall 6 extends downwardly from upper portion 4 of housing 2 at an angle 24, while the inner side wall 8 extends downwardly from upper portion 4 of housing 2 at an angle 26. Angles 24 and 26 may be equal, although examples are not so limited, and angle 24 may differ from angle 26. In a preferred embodiment, angles 24 and 26 can be between 12 degrees and 18 degrees; however, other angles may be used. Additionally or alternately, preferably the vertical dimension (e.g., height 3) of the side walls is employed such that sidewalls 6, 8 have enough height to further aid in keeping sensor 1 securely on the toilet bowl, not too high so as to cause fitment issues with the toilet seat, nor be too long to get soiled because it extends further down into the toilet from the top edge of the toilet bowl. As an example, an earlier design did not fit some name brand toilets, and this was overcome by increasing the space between the side walls, changing the side wall angle, and decreasing the side wall height. Accordingly, the inventor has surprisingly discovered the following exemplary dimensions for the sidewalls: width 7 as noted above; height 3 of about 0.2 inches to 0.8, inches, and more preferably from about 0.4 inches to 0.6 inches; and, angles 24, 26 from about 5 degrees to 50 degrees, and more preferably from about 10 degrees to 30 degrees.

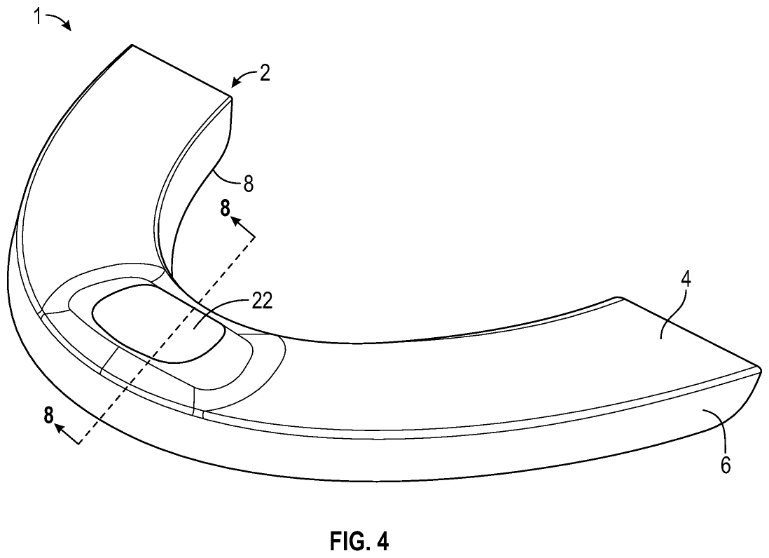

FIG. 4 is an example of a toilet sensor 1 consistent with the present disclosure. More particularly. FIG. 4 shows toilet sensor 1 as assembled, i.e., with the various components shown in FIGS. 1 and 2 in their useable configuration. Toilet sensor 1 includes a housing 2. Housing 2 includes an upper portion 4. Although not readily visible in FIG. 4, housing 2 further includes a lower portion, which, when in this assembled configuration, is joined with the upper portion 4. Upper portion 4 of housing 2 includes an outer side wall 6 and an inner side wall 8. Together with the lower portion, upper portion 4 of housing 2 fully contains the sensing components, such as first film layer 12, second film layer 16 and processing circuitry 20, all described with respect to FIGS. 1 and 2. As shown in FIG. 4, upper portion 4 of housing 4 further includes a casing 22. As previously described with respect to FIGS. 1 and 2, casing 22 may contain the processing circuitry; this is also shown in FIG. 8.

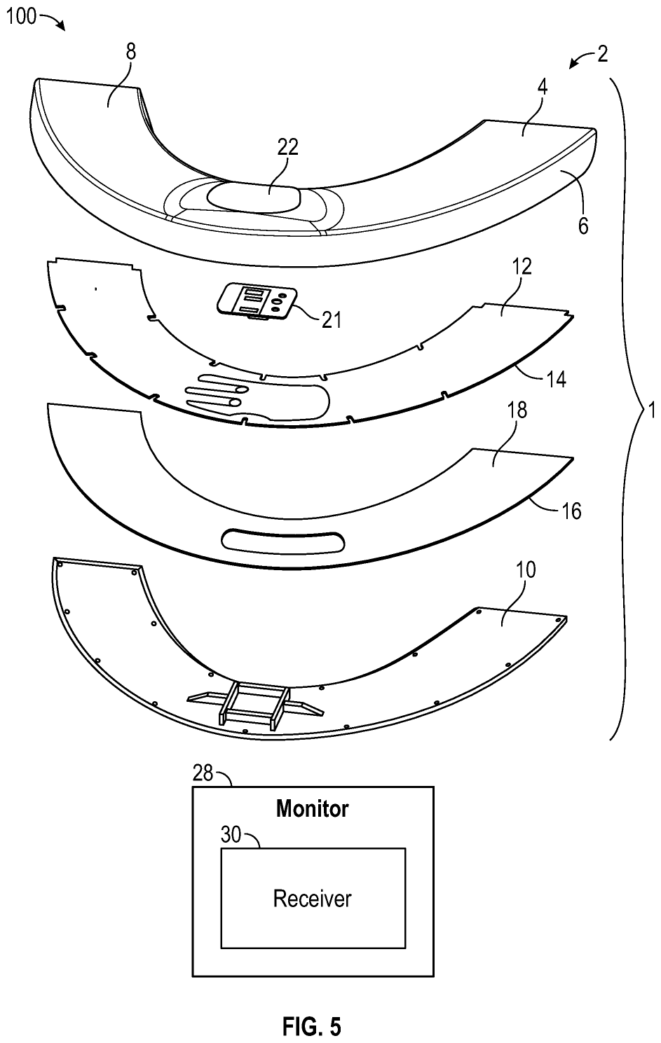

FIG. 5 is an example sensor system 100 consistent with the present disclosure. Sensor system 100 may include a sensor device 1. Sensor device 1 may include a housing 2. Housing 2 may include an upper portion 4, an outer side wall 6, and an inner side wall 8, with outer side wall 6 and inner side wall 8 extending downwardly from the upper portion 8 of housing 2.

A plurality of spacers may be located anywhere along the length of the sidewalls 6, 8, and for example, at an end of the housing as seen in FIGS. 11-13 for example. As used herein, a spacer refers to a piece used to create or maintain a desired amount of space elsewhere between two objects. With respect to the present disclosure, ends 9 sitting across from each other at ends of respective sidewalls 6. 8 may be used to create a desired gap between sidewalls 6, 8 and the toilet bowl that sensor 1 sits atop, for the length of the sidewalls that are spaced from ends 9. More specifically, upper portion 4 of housing 2 may have a first width along a majority of the length of sidewalls 6, 8 (e.g., as seen in FIG. 3 it can be width 7 plus the distance of each gap from the outer most edge of sidewalls 6, 8 to where 7 ends), while ends 9 may have a second width that is less than the first width (e.g., using FIG. 3 again, and ascribing width 7 to be the total distance from the outer most edge of sidewalls 6, 8 at their ends 9). That is, the ends 9 of the upper portion 4 of housing 2 may reduce the width of the U-shaped channel formed thereby such that the ends 9 have a second width less the first width. As shown particularly in FIG. 11, the ends 9 of outer sidewall 6 may flare in at their ends and the ends 9 of inner sidewall 8 may flare out at their ends, creating the second width less than the first width. For example, such a spacing dimension can preferably be a reduction in width between the sidewalls 6, 8 from about 0.04 inch to 1 inch. more preferably from about 0.075 inch to 0.75 inch, still more preferably from about 0.1 inch to 0.5 inch, and even more preferably from about 0.125 inch to 0.4 inch. For example, each sidewall 6, 8 can be 0.15 inches per side, for a total of 0.3 inches narrower in combination.

Additionally, such narrower second width can be located at two or more locations along the length of one or both sidewalls 6 and 8, i.e., a wavy side wall or indentations or spacing members attached to at least one of the sidewalls 6, 8 and located between sidewalls 6, 8. Without being limited to a theory of understand, the inventor has discovered that the selective placement of spacers for sidewalls 6, 8, better helps consistently position the housing on the toilet bowl during use, for example, preferably doing so for at least the area that is one to three inches in from each end 9 as this tends to be where the toilet seat bumper typically contacts the toilet bowl. Further, in this way, the housing can be configured to position the film layers outer edges in non-critical locations so the film layers active area is more consistently positioned between the toilet seat and the toilet bowl where force of the user (i.e., the user's weight) gets applied during toileting. Even more preferably, the selective placement of spacers can help prevent the sensor from sliding to a position where the upper portion is right up against an upper edge of the toilet bowl which could decrease more reliable sensing by the sensor.

Housing 2 may further include a lower portion 10. As previously discussed, lower portion 10 may be joinable with upper portion 4, such that when upper portion 4 and lower portion 10 are joined together, a closed or substantially closed housing is formed. In some examples, the ends of the lower portion 10 of housing 2 may join with the upper portion 4 of housing 2 at an upward projecting lip 27 of the upper portion 4 (FIG. 13). This may reduce the visibility of the seam at the joining location, and/or enable the end most ends of portion 10 to tuck behind lip 27 when the sensor is fully assembled together.

Sensor device 1 may further include a first film layer 12. First film layer 12 may include a first conductive layer 14. A second film layer 16 may also be present and may include a second conductive layer 18. When installed in sensor device 1, first conductive layer 14 and second conductive layer 18 may be selectively engageable. That is, first conductive layer 14 and second conductive layer 18 may be disposed such that they face one another and may touch or otherwise engage when, for example, pressure is applied to sensing device 1.

A printed circuit board 21 may be included as part of sensor device 1. As used herein, a printed circuit board refers to a non-conductive material onto which conductive lines are printed or etched. Electrical components may then be connected to the printed circuit board and due to the conductive lines, are connected to form a circuit. Printed circuit board 21 may include a variety of electrical components, including a battery and an antenna. In a preferred embodiment, the antenna is a wireless antenna; however, examples are not so limited, and the printed circuit board, with or without an antenna, may be wire connected to the receiver, e.g., via a wired connection. Printed circuit board 21 may be housed within housing 2, and more particularly, may be housed within a casing 22 disposed in the upper portion 4 of housing 2.

Printed circuit board 21 may further be coupled to the first film layer 12 and the second film layer 16. More particularly, printed circuit board 21 may be coupled to the first conductive layer 14 and/or the second conductive layer 18, such that when an electrical circuit is completed via engagement of the first film layer 12 and the second film layer 16, printed circuit board 21 may also be a part of the electrical circuit. As such, when first film layer 12 and second film layer 16 engage, printed circuit board 21 may note that there is an electrical connection. If first film layer 12 and second film layer 16 subsequently disengage. or the electrical connection is otherwise interrupted, printed circuit board 21 may detect a change in electrical connection status.

Sensor system 100 may further include an external monitor 28. External monitor 28 may refer to a computer, a nurse call device, an external alarm, or any other suitable device. External monitor 28 may include a receiver 30. As used herein, a receiver refers to an electronic device that receives transmissions and converts them to an electrical or otherwise usable signal. Receiver 30 may be paired or coupled with the antenna contained on printed circuit board 21, such that receiver 30 may receive signals from the antenna. In a preferred embodiment, receiver 30 is a wireless receiver and receives wireless signals from the antenna, although examples are not so limited, and the receiver could be wire connected to the toilet sensor 1.

More particularly, receiver 30 may receive signals from the antenna when the printed circuit board 21 detects a change in electrical connection status. When first film layer 12 and second film layer 16 engage and subsequently disengage, printed circuit board 21 may detect a change in the electrical connection status. This detection of change in electrical connection status may cause printed circuit board 21 to instruct the antenna to transmit a signal to the receiver 30. More particularly, the signal transmitted to receiver 30 may be a signal that a change in electrical connection status has occurred. Upon receipt of this signal, receiver 30 may transmit the signal to monitor 28 and may cause monitor 28 to sound an alarm or otherwise alert an external user that the electrical connection status has changed.

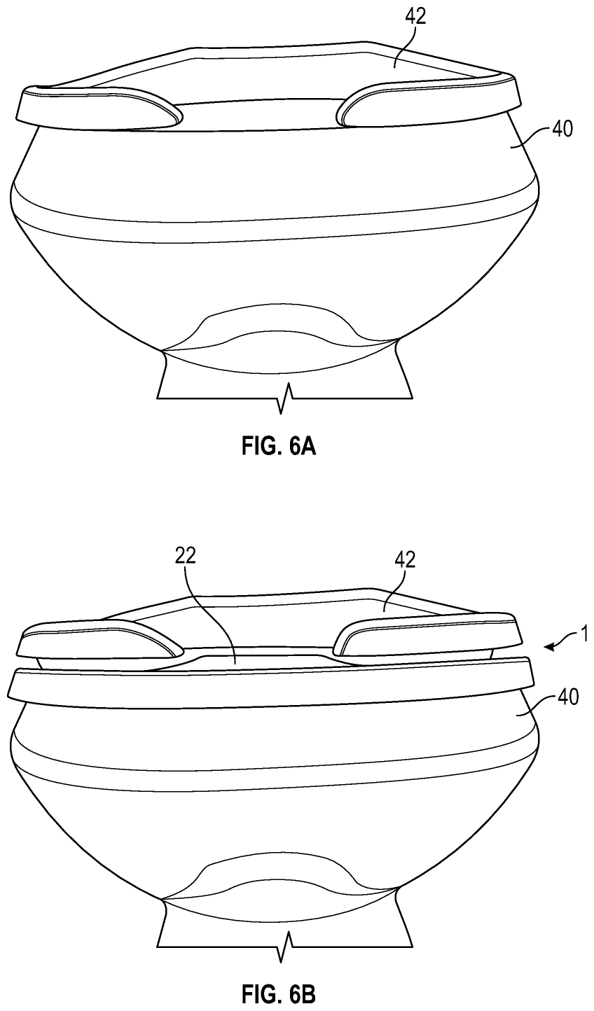

In some examples, a sensor may be a self-locating sensor for use with a toilet bowl. The toilet bowl 40 may have a toilet seat 42 hingedly attached thereto. The sensor, which may be akin to the sensors described previously with respect to FIGS. 1-5, or shown in FIGS. 6A/6B through 13, may include a housing. In some examples, the housing may be substantially parabolic in shape, and may include a vertex with housing legs extending and projecting away from the vertex. The housing may have a substantially flat horizontal surface, with a raised area of the housing projecting above the substantially flat horizontal surface. More particularly, the raised area of the housing may be located adjacent to the vertex. The housing may further have an inner surface, adjacent to which may be a sensor layer. The sensor layer may be akin to the first film layer and/or the second film layer discussed with respect to FIGS. 1-4, although examples are not so limited. Processing circuitry may be located within the raised area of the housing, such that the processing circuitry is located adjacent to the vertex of the housing. The processing circuitry may be akin to a microcontroller and/or printed circuit board described with respect to FIGS. 1-4. The processing circuitry may further contain a battery and an antenna and may further be coupled to the sensor layer.

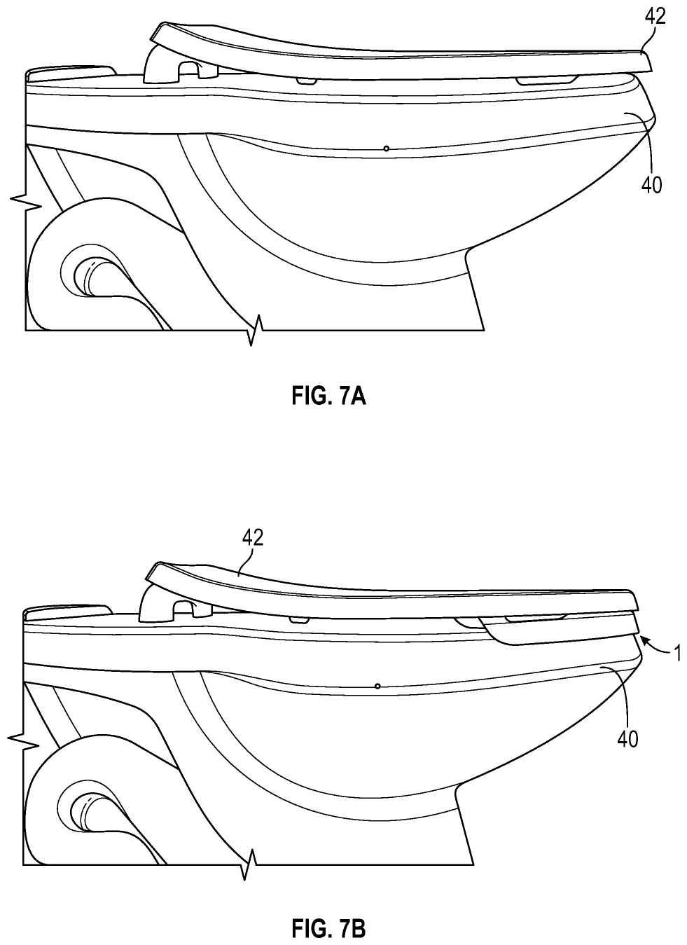

In use, the self-locating sensor is positionable between the toilet bowl and the toilet seat, and preferably, more easily and/or reliably so than ever before possible. That is, and without being limited to a theory of understanding, the inventor has specifically discovered how to and designed, in increasing order of preference, sensor 1 to be self-locating due to one or more of: the sidewalls, the sidewall(s) height, the sidewall(s) angle, the width between the sidewalls, the substantially parabolic shape of the housing, the low-profile of the housing, and the raised area of the housing projecting above the substantially flat horizontal surface adjacent to the vertex. More particularly, accordingly, the self-locating sensor may be positionable such that the vertex of the housing is located adjacent to a front edge of the toilet bowl. In some examples, the toilet seat may include a front-end gap as seen in FIGS. 6A and 6B, such that when the self-locating sensor is positioned on the toilet bowl, the vertex is adjacent to the front edge of the toilet bowl and the raised area of the housing is located in the front-end gap of the toilet seat. However, even without a toilet seat front-end gap in the toilet seat, the sensor's low-profile enables use with a fully closed encircling toilet seat (i.e., like a donut), but likely with a bit more noticeability by the user as the raised area of the upper housing may cause the front end of the toilet seat to extend upward, especially as compared to how the toilet seat would be positioned on the toilet bowl without the sensor therebetween. Meanwhile, the housing legs may be located on opposite sides of the toilet bowl and may project away from the vertex. In this way, still more preferably, the self-locating sensor covers a sufficient portion of the area between the toilet seat and the toilet bowl for sensing purposes and is able to have the toilet seat lowered thereupon, as in FIGS. 6B and 7B for example. Additional discussion of embodiments in various scopes now follows:
A. A sensor used in combination with a monitoring system. The sensor including a housing. The housing including: a convex upper portion; an outer sidewall extending downwardly from the convex upper portion; an inner sidewall extending downwardly from the convex upper portion; and a convex lower portion joinable with the convex upper portion. A first film layer having a first conductive area, the first film layer is disposed adjacent to the convex upper portion of the housing such that the first conductive area faces opposite the convex upper portion of the housing. A second film layer having a second conductive area, where: the second film layer is disposed adjacent to the first film layer such that the second conductive area faces the first conductive area; and the second conductive layer is selectively separated from the first conductive layer. Processing circuitry contained within the housing.
B. A sensor for use with a toilet seat. The sensor including a housing. The housing including an upper portion. The upper portion including an outer sidewall and an inner sidewall extending downwardly and at an angle. The upper portion including a casing and the upper portion is manufactured of a first material having a first characteristic. A lower portion, where the lower portion is joined with the upper portion. The lower portion is manufactured of a second material also having the first characteristic but having a different amount of the first characteristic than the upper portion. A first film layer having a first conductive layer, where the first film layer is disposed adjacent to the upper portion of the housing such that the first conductive area faces opposite the upper portion of the housing. A second film layer having a second conductive layer, where the second film layer is disposed adjacent to the first film layer such that the second conductive area faces the first conductive area and the second conductive layer is separated from the first conductive layer. The first conductive layer and the second conductive layer are selectively engageable. A printed circuit board contained within the casing of the housing.
C. The sensor of any of the prior sensor embodiments, wherein the convex upper portion of the housing further comprises a casing for the processing circuitry.
D. The sensor of any of the prior sensor embodiments, wherein the housing is substantially parabolic in shape.
E. The sensor of any of the prior sensor embodiments, wherein at least one of the outer sidewall and the inner sidewall extend downward from the convex upper portion of the housing at an angle.
F. The sensor of any of the prior sensor embodiments, wherein the second conductive layer is separated from the first conductive layer by a pattern of non-conductive spacing material.
G. The sensor of any of the prior sensor embodiments, wherein the non-conductive spacing material is deposited on the first film layer.
H. The sensor of any of the prior sensor embodiments, wherein the non-conductive spacing material is deposited on the second film layer.
I. The sensor of any of the prior sensor embodiments, wherein the first conductive area and the second conductive area extend over a majority of the first film layer and the second film layer, respectively.
J. The sensor of any of the prior sensor embodiments, wherein: the first conductive layer has a plurality of distinct conductive paths between the printed circuit board and a plurality of sensing areas; and, the second conductive layer has a patterned set of conductive material such that the second conductive area bridges the plurality of distinct conductive paths contained on the first conductive layer.
K. The sensor of any of the prior sensor embodiments, wherein the housing, the first film layer, and the second film layer are substantially parabolic in shape.
L. The sensor of any of the prior sensor embodiments, wherein: the printed circuit board or the processing circuitry further contains a wireless antenna and a battery; and, the processing circuitry or printed circuit board is coupled to the first film layer and the second film layer.
M. The sensor of any of the prior sensor embodiments, wherein the first characteristic is one from the group of durometer, elastomeric and coefficient of friction.
N. The sensor of any of the prior sensor embodiments, wherein the first characteristic is durometer and the upper portion has a higher durometer than does the lower portion.
O. The sensor of any of the prior sensor embodiments, wherein the first characteristic is coefficient of friction and the upper portion has a lower coefficient of friction than does the lower portion.
P. The sensor of any of the prior sensor embodiments, wherein the first characteristic is elastomeric and the upper portion is less elastic than is the lower portion.
Q. A sensor system including a sensor device for use with a toilet seat. The sensor including a housing. A first film layer having a first conductive layer. A second film layer having a second conductive layer, where the first conductive layer and the second conductive layer are selectively engageable. A printed circuit board contained within the housing. A receiver contained within an external monitor, where the receiver is in communication with the printed circuit board.
R. The sensor system of any of the prior system embodiments, wherein the printed circuit board is coupled to the first film layer and the second film layer such that the printed circuit board detects a change in electrical connection status when the first conductive layer and the second conductive layer engage and subsequently disengage.
S. The sensor system of any of the prior system embodiments, wherein the printed circuit board further contains a wireless antenna and a battery, and the receiver contained within the external monitor is a wireless receiver in communication with the printed circuit board via the wireless antenna.
T. The sensor system of any of the prior system embodiments, wherein detection of the change in electrical connection status by the printed circuit board or processing circuitry is communicated with the receiver.
U. The sensor system of any of the prior system embodiments, wherein detection of the change in electrical connection status by the printed circuit board or processing circuitry further is communicated with wireless receiver via the wireless antenna.
V. The sensor system of any of the prior system embodiments, wherein the signal transmitted a signal alerting that a change in electrical connection status has occurred.
W. The sensor system of any of the prior system embodiments, wherein the housing further includes: an upper portion, where the upper portion further includes a casing for the printed circuit board; an outer sidewall extending downward from the upper portion of the housing; an inner sidewall extending downward from the upper portion of the housing; a lower portion joined with the upper portion; and, a plurality of spacers located along a length of the housing.
X. The sensor system of any of the prior system embodiments, wherein the first film layer and the second film layer are disposed within the housing between the upper portion and the lower portion.
Y. The sensor system of any of the prior system embodiments, wherein: the upper portion and the lower portion have a first width; the plurality of spacers have a second width; and, the plurality of spacers are disposed along the length of the housing such that a portion of the housing has a third width, where the third width is the first width minus the second width.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process. electrical, and/or structural changes may be made without departing from the scope of the present disclosure.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of an element and/or feature can refer to one or more of such elements and/or features.

The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the applicable mechanical tools arts, and all such modifications and other embodiments are intended and deemed to be within the scope of the present disclosure.

1. A sensor used in combination with a monitoring system, the sensor comprising:
a housing, wherein the housing comprises:
a convex upper portion;
an outer sidewall extending downwardly from the convex upper portion;
an inner sidewall extending downwardly from the convex upper portion; and
a convex lower portion joinable with the convex upper portion;
a first film layer having a first conductive area, wherein the first film layer is disposed adjacent to the convex upper portion of the housing such that the first conductive area faces opposite the convex upper portion of the housing;
a second film layer having a second conductive area, wherein:
the second film layer is disposed adjacent to the first film layer such that the second conductive area faces the first conductive area; and
the second conductive layer is selectively separated from the first conductive layer; and
processing circuitry contained within the housing.

2. The device of claim 1, wherein the convex upper portion of the housing further comprises a casing for the processing circuitry.

3. The device of claim 1, wherein the housing is substantially parabolic in shape.

4. The device of claim 1, wherein at least one of the outer sidewall and the inner sidewall extend downward from the convex upper portion of the housing at an angle.

5. The device of claim 1, wherein the second conductive layer is separated from the first conductive layer by a pattern of non-conductive spacing material.

6. The device of claim 5, wherein the non-conductive spacing material is deposited on the first film layer.

7. The device of claim 5, wherein the non-conductive spacing material is deposited on the second film layer.

8. The device of claim 1, wherein the processing circuitry further comprises a battery and a wireless antenna.

9. A sensor system, comprising:
a sensor device for use with a toilet seat, the sensor comprising:
a housing;
a first film layer having a first conductive layer;
a second film layer having a second conductive layer, wherein the first conductive layer and the second conductive layer are selectively engageable; and
processing circuitry contained within the housing; and
a receiver contained within an external monitor, wherein the receiver is in communication with the processing circuitry.

10. The system of claim 9, wherein the processing circuitry includes a printed circuit board, and the printed circuit board is coupled to the first film layer and the second film layer such that the printed circuit board is affected by a change in electrical connection status when the first conductive layer and the second conductive layer engage and subsequently disengage.

11. The system of claim 10, wherein detection of the change in electrical connection status by the printed circuit board is communicated with the receiver.

12. The system of claim 11, wherein a signal is transmitted by the printed circuit board to the receiver to alert that a change in electrical connection status has occurred.

13. The system of claim 10, wherein the printed circuit board further comprises a wireless antenna and a battery, and the receiver contained within the external monitor is a wireless receiver in communication with the printed circuit board via the wireless antenna.

14. The system of claim 13, wherein detection of the change in electrical connection status by the printed circuit board is communicated with the wireless receiver via the wireless antenna.

15. The system of claim 14, wherein the signal transmitted by the wireless antenna is a signal alerting that a change in electrical connection status has occurred.

16. The system of claim 9, wherein the housing further comprises:
an upper portion, wherein the upper portion further includes a casing for the printed circuit board;
an outer sidewall extending downward from the upper portion of the housing;
an inner sidewall extending downward from the upper portion of the housing;
a lower portion joined with the upper portion;
a plurality of spacers located along a length of the housing.

17. The system of claim 16, wherein the first film layer and the second film layer are disposed within the housing between the upper portion and the lower portion.

18. The system of claim 16, wherein:
the upper portion and the lower portion have a first width;
the plurality of spacers have a second width; and
the plurality of spacers are disposed along the length of the housing such that a portion of the housing has a third width, wherein the third width is the first width minus the second width.

19. A sensor for use with a toilet seat, the sensor comprising:
a housing, wherein the housing comprises:
an upper portion, wherein:
the upper portion includes an outer sidewall and an inner sidewall extending downwardly and at an angle;
the upper portion includes a casing; and
the upper portion is manufactured of a first material having a first characteristic; and
a lower portion, wherein:
the lower portion is joined with the upper portion; and
the lower portion is manufactured of a second material also having the first characteristic but having a different amount of the first characteristic than the upper portion;
a first film layer having a first conductive layer, wherein the first film layer is disposed adjacent to the upper portion of the housing such that the first conductive area faces opposite the upper portion of the housing;
a second film layer having a second conductive layer, wherein:
the second film layer is disposed adjacent to the first film layer such that the second conductive area faces the first conductive area;
the second conductive layer is separated from the first conductive layer; and
the first conductive layer and the second conductive layer are selectively engageable; and
processing circuitry contained within the casing of the housing.

20. The sensor of claim 19, wherein the first conductive area and the second conductive area extend over a majority of the first film layer and the second film layer, respectively.

21. The sensor of claim 20, wherein:
the first conductive layer has a plurality of distinct conductive paths between the processing circuitry and a plurality of sensing areas; and
the second conductive layer has a patterned set of conductive material such that the second conductive area bridges the plurality of distinct conductive paths contained on the first conductive layer.

22. The sensor of claim 19, wherein the housing, the first film layer, and the second film layer are substantially parabolic in shape.

23. The sensor of claim 19, wherein the housing, the first film layer, and the second film layer are a rounded in shape.

24. The sensor of claim 19, wherein:
the processing circuitry further comprises a wireless antenna and a battery; and
the processing circuitry is coupled to the first film layer and the second film layer.

25. The sensor of claim 19, wherein:
the processing circuitry further includes a wired connection; and
the processing circuitry is coupled to the first film layer and the second film layer.

26. The sensor of claim 19, wherein the first characteristic is one from the group of durometer, elastomeric and coefficient of friction.

27. The sensor of claim 26, wherein the first characteristic is durometer and the upper portion has a higher durometer than does the lower portion.

28. The sensor of claim 26, wherein the first characteristic is coefficient of friction and the upper portion has a lower coefficient of friction than does the lower portion.

29. The sensor of claim 26, wherein the first characteristic is elastomeric and the upper portion is less elastic than is the lower portion.

30. A self-locating sensor for use with a toilet bowl having a toilet seat hingedly attached thereto, wherein the self-locating sensor comprises:
a housing having a substantially flat horizontal surface, wherein:
the housing is formed as a substantially parabolic shape;
the housing includes a vertex with housing legs projecting away from the vertex; and
the housing has an inner surface and a sensor layer located adjacent the inner surface;
a raised area of the housing projecting above the substantially flat horizontal surface adjacent to the vertex;
processing circuitry located with the raised area of the housing
wherein the self-locating sensor is positionable between the toilet bowl and the toilet seat such that (i) the vertex of the housing is located adjacent to a front edge of the toilet bowl and (ii) the housing legs are located on opposite sides of the toilet bowl projecting away from the vertex.

31. The self-locating sensor of claim 30, wherein:
the toilet seat has a front-end gap formed therein; and
the raised area of the housing is located in the front-end gap when the self-locating sensor is positionable between the toilet bowl and the toilet seat.

32. The self-locating sensor of claim 31, wherein the processing circuitry further comprises a battery and a wireless antenna.
